(19) United States
(12) Patent Application Publication
(10) Pub. No.: US 2026/0278104 A1
(43) Pub. Date: Sep. 17, 2026

(54) INFORMATION PROCESSING APPARATUS

(71) Applicant: TOYOTA JIDOSHA KABUSHIKI KAISHA, Toyota-shi (JP)

(72) Inventor: Yuta TSUKADA, Toyota-shi (JP)

(73) Assignee: TOYOTA JIDOSHA KABUSHIKI KAISHA, Toyota-shi (JP)

(21) Appl. No.: 19/550,771

(22) Filed: Feb. 26, 2026

(30) Foreign Application Priority Data
Mar. 12, 2025 (JP) 2025-039253

(51) Int. Cl. G06F 21/57; B60R 16/023

(52) U.S. Cl. CPC G06F 21/57; B60R 16/023

(57) ABSTRACT

The information processing apparatus includes a storage device and a processing circuit. The storage device stores a database including data in which a measure MET against a risk present in each feature is associated with the feature, and data in which a security function for realizing each measure MET is associated with each measure MET, for each feature of a plurality of electronic control devices that realize a plurality of functions of the vehicle. The processing circuit acquires the feature of the electronic control device. The processing circuit derives, as the security function to be implemented in the electronic control device, the security function corresponding to the acquired feature by referring to the database.

### CROSS-REFERENCE TO RELATED APPLICATION

This application claims priority to Japanese Patent Application No. 2025-039253 filed on Mar. 12, 2025. The disclosure of the above-identified application, including the specification, drawings, and claims, is incorporated by reference herein in its entirety.

### BACKGROUND

### 1. Technical Field

The present disclosure relates to an information processing apparatus.

### 2. Description of Related Art

Japanese Unexamined Patent Application Publication No. 2024-013374 (JP 2024-013374 A) discloses an information processing apparatus that stores a database created based on a result of risk assessment. The information processing apparatus stores a database that stores a list of measures to be taken for an alert that issues a warning of a threat that leads to an incident, and a database of software for which a measure is required to be implemented. In order to generate the database, in addition to a specification of each device, a specification of software, and a rule for generating an alert, a result of risk assessment performed on each device is required.

A vehicle is equipped with a plurality of electronic control units (ECUs). The electronic control device may be a target of a cyber attack. Therefore, it is necessary to implement a security function in the electronic control device. In order to determine which security function should be implemented in the electronic control device, it is necessary to perform risk assessment on the electronic control device. A suitable security function for each electronic control device is derived based on the result of the risk assessment.

### SUMMARY

In order to derive the security function to be implemented for each of the electronic control devices having different functions, individual risk assessments are performed for each electronic control device. In this case, as the number of electronic control devices increases, the time required to derive the security function for all the electronic control devices increases.

An information processing apparatus for solving the above-described problem is an information processing apparatus that derives a security function to be implemented in an electronic control device mounted on a vehicle. The information processing apparatus includes a storage device, and a processing circuit. The storage device stores a database based on a result of risk assessment performed on features of a plurality of electronic control devices that realize a plurality of functions of the vehicle, the database including for each feature, data in which a measure against a risk present in each feature is associated with the feature, and for each measure, data in which the security function for realizing each measure is associated with the measure. The processing circuit executes acquiring the features of the electronic control device, and deriving, by referring to the database stored in the storage device, the security function corresponding to the features that are acquired, as the security function to be implemented in the electronic control device.

The information processing apparatus can derive the security function to be implemented in each electronic control device without individually performing the risk assessment on each of the electronic control devices provided in the vehicle.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic diagram showing an information processing apparatus according to a first embodiment;

FIG. 2 is a table showing data stored in the database shown in FIG. 1;

FIG. 3 is a flowchart showing a series of processes performed by the processing circuit shown in FIG. 1;

FIG. 4 is a table showing a feature of the electronic control device acquired by the processing circuit shown in FIG. 1;

FIG. 5 is a table showing data stored in a database according to a second embodiment; and

FIG. 6 is a table showing a feature of the electronic control device acquired by the processing circuit according to the second embodiment.

### DETAILED DESCRIPTION OF EMBODIMENTS

### First Embodiment

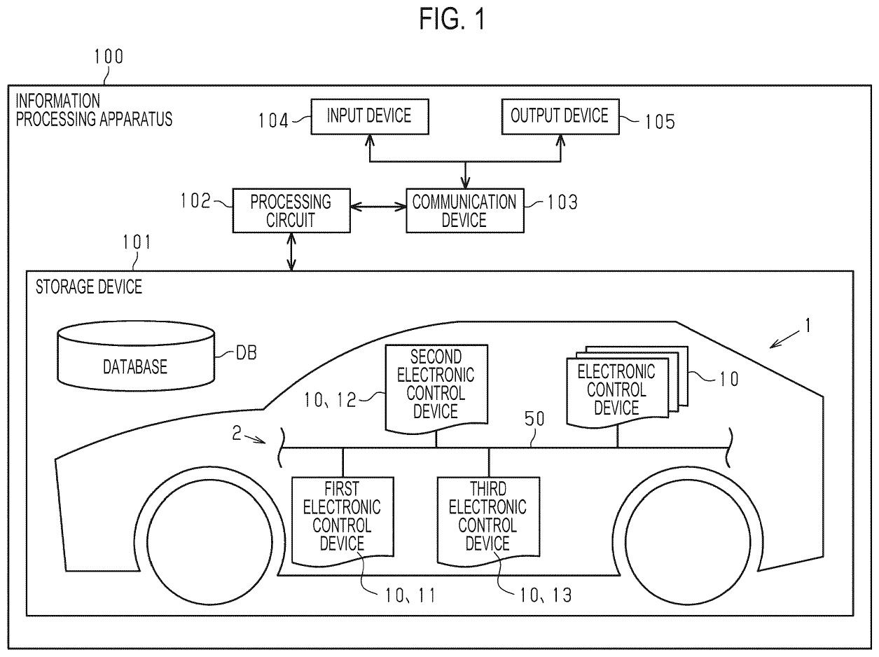

Hereinafter, an information processing apparatus 100 according to the first embodiment will be described with reference to FIGS. 1 to 4.

### Overview of Information Processing Apparatus 100

As shown in FIG. 1, the information processing apparatus 100 includes a storage device 101 in which a program is stored, and a processing circuit 102 that executes the program to execute various types of process. The processing circuit 102 includes a processor. The information processing apparatus 100 is used to derive a security function SE to be implemented in an electronic control device 10 mounted on a vehicle 1, which will be described below.

The information processing apparatus 100 includes a communication device 103, an input device 104, and an output device 105. The input device 104 is used by a user of the information processing apparatus 100 to input various types of information to the information processing apparatus 100. The input device 104 is configured of, for example, a keyboard, a pointing device such as a mouse, and a touch device. The processing circuit 102 and the input device 104 are configured to communicate with each other via the communication device 103. The output device 105 presents information to the user of the information processing apparatus 100 by an image, printing, or the like. The output device 105 is, for example, a display and a printer. The processing circuit 102 and the output device 105 are configured to communicate with each other via the communication device 103.

The storage device 101 stores a database DB and a simulation model that reproduces a vehicle-mounted network 2 mounted on the vehicle 1. The vehicle-mounted network 2 is configured of a plurality of electronic control devices 10. The electronic control devices 10 are connected to each other via a communication bus 50 to be communicable. In this way, the electronic control devices 10 constitute the vehicle-mounted network 2. Each of the electronic control devices 10 realizes each of a plurality of functions FN of the vehicle 1. For example, a first electronic control device 11, a second electronic control device 12, and a third electronic control device 13 shown in FIG. 1 are the electronic control devices 10 that realize different functions FN, respectively.

The database DB is created based on a result of risk assessment performed on the feature of the electronic control devices 10 that realize the functions FN of the vehicle 1. Specifically, the database DB is created based on a result of risk assessment performed for each combination pattern PN indicated by a combination of the function FN of the vehicle 1 realized by the electronic control device 10 and the plurality of data. The data are first data DA_1, second data DA_2, third data DA_3, and fourth data DA_4, which will be described below. As a result, the information processing apparatus 100 can obtain information indicating the measure MET against the risk present in each combination pattern PN and the security function SE for realizing the measure MET.

### Database Db

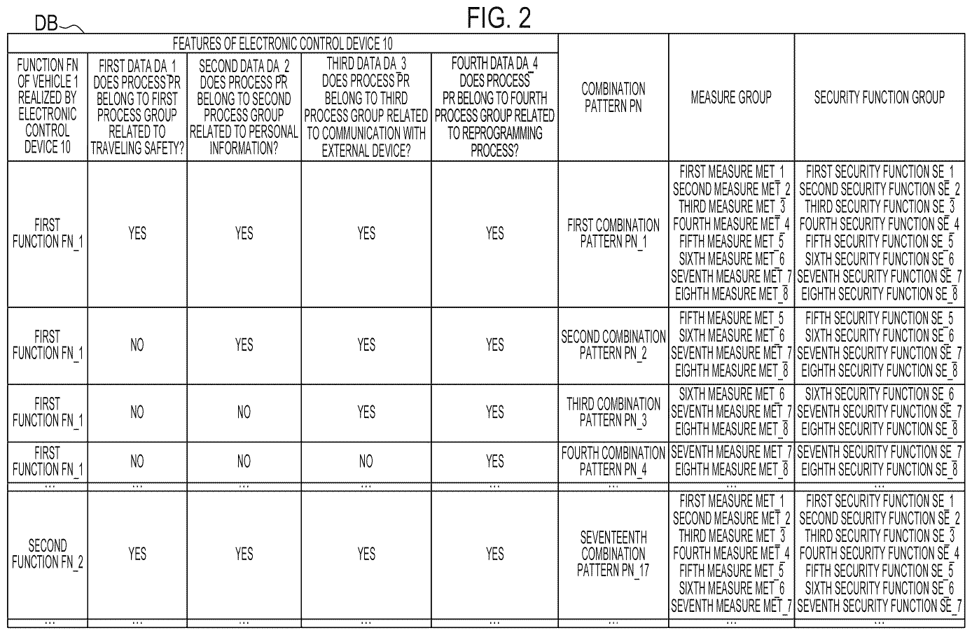

As shown in FIG. 2, in the database DB, the feature of the electronic control device 10 is indicated by a combination of the function FN of the vehicle 1 realized by the electronic control device 10 and the data. Specifically, the feature of the electronic control device 10 is indicated by a combination of the function FN, the first data DA_1, the second data DA_2, the third data DA_3, and the fourth data DA_4.

The first data DA_1 indicates whether the process PR executed by the electronic control device 10 is the process belonging to a first process group including a plurality of processes related to traveling safety of the vehicle 1. In a case where the process PR belongs to the first process group, “YES” is input as an input value for the database DB. In a case where the process PR does not belong to the first process group, “NO” is input as an input value for the database DB.

The second data DA_2 indicates whether the process PR executed by the electronic control device 10 is the process belonging to a second process group including the processes related to personal information. In a case where the process PR belongs to the second process group, “YES” is input as an input value for the database DB. In a case where the process PR does not belong to the second process group, “NO” is input as an input value for the database DB.

The third data DA_3 indicates whether the process PR executed by the electronic control device 10 is the process belonging to a third process group including the processes related to communication with an external device. In a case where the process PR belongs to the third process group, “YES” is input as an input value for the database DB. In a case where the process PR does not belong to the third process group, “NO” is input as an input value for the database DB.

The fourth data DA_4 indicates whether the process PR executed by the electronic control device 10 is the process belonging to a fourth process group including the functions related to the reprogramming process of an in-vehicle device. In a case where the process PR belongs to the fourth process group, “YES” is input as an input value for the database DB. In a case where the process PR does not belong to the fourth process group, “NO” is input as an input value for the database DB.

The database DB includes a plurality of combination patterns PN of the function FN, the first data DA_1, the second data DA_2, the third data DA_3, and the fourth data DA_4. In the database DB, a measure group is associated with each combination pattern PN. The measure group is a collection of measures MET against the risk present in each combination pattern PN associated with the measure group. In the database DB, a security function group is associated with each measure group. The security function group is a collection of security functions SE for realizing each measure MET included in the measure group associated with the security function group. That is, the storage device 101 stores, in the database DB, data in which the measure MET against the risk present in each combination pattern PN is associated with each combination pattern PN, and data in which the security function SE for realizing each measure MET is associated with each measure MET.

For example, a combination pattern PN in which the function FN of the vehicle 1 realized by the electronic control device 10 is a first function FN_1 and the process PR executed by the electronic control device 10 belongs to all of the first process group, the second process group, the third process group, and the fourth process group is a first combination pattern PN_1. The measures MET included in the measure group corresponding to the first combination pattern PN_1 are a first measure MET_1, a second measure MET_2, a third measure MET_3, a fourth measure MET_4, a fifth measure MET_5,a sixth measure MET_6, a seventh measure MET_7, and an eighth measure MET_8.

The security function SE corresponding to the first measure MET_1 is a first security function SE_1. The security function SE corresponding to the second measure MET_2 is a second security function SE_2. The security function SE corresponding to the third measure MET_3 is a third security function SE_3. The security function SE corresponding to the fourth measure MET_4 is a fourth security function SE_4. The security function SE corresponding to the fifth measure MET_5 is a fifth security function SE_5. The security function SE corresponding to the sixth measure MET_6 is a sixth security function SE_6. The security function SE corresponding to the seventh measure MET_7 is a seventh security function SE_7. The security function SE corresponding to the eighth measure MET_8 is an eighth security function SE_8. Therefore, the security functions SE included in the security function group corresponding to the measure group corresponding to the first combination pattern PN_1 are the first security function SE_1, the second security function SE_2, the third security function SE_3, the fourth security function SE_4, the fifth security function SE_5, the sixth security function SE_6, the seventh security function SE_7, and the eighth security function SE_8.

For example, a combination pattern PN in which the function FN of the vehicle 1 realized by the electronic control device 10 is the first function FN_1, the process PR executed by the electronic control device 10 does not belong to the first process group, and the process PR belongs to the second process group, the third process group, and the fourth process group is a second combination pattern PN_2. The measures MET included in the measure group corresponding to the second combination pattern PN_2 are the fifth measure MET_5, the sixth measure MET_6, the seventh measure MET_7, and the eighth measure MET_8. The security functions SE included in the security function group corresponding to the measure group corresponding to the second combination pattern PN_2 are the fifth security function SE_5, the sixth security function SE_6, the seventh security function SE_7, and the eighth security function SE_8.

For example, a combination pattern PN in which the function FN of the vehicle 1 realized by the electronic control device 10 is the first function FN_1, the process PR executed by the electronic control device 10 does not belong to the first process group and the second process group, and the process PR belongs to the third process group and the fourth process group is a third combination pattern PN_3. The measures MET included in the measure group corresponding to the third combination pattern PN_3 are the sixth measure MET_6, the seventh measure MET_7, and the eighth measure MET_8. The security functions SE included in the security function group corresponding to the measure group corresponding to the third combination pattern PN_3 are the sixth security function SE_6, the seventh security function SE_7, and the eighth security function SE_8.

For example, a combination pattern PN in which the function FN of the vehicle 1 realized by the electronic control device 10 is the first function FN_1, the process PR executed by the electronic control device 10 does not belong to the first process group, the second process group, and the third process group, and the process PR belongs to the fourth process group is a fourth combination pattern PN_4. The measures MET included in the measure group corresponding to the fourth combination pattern PN_4 are the seventh measure MET_7 and the eighth measure MET_8. The security functions SE included in the security function group corresponding to the measure group corresponding to the fourth combination pattern PN_4 are the seventh security function SE_7 and the eighth security function SE_8.

For example, a combination pattern PN in which the function FN of the vehicle 1 realized by the electronic control device 10 is the second function FN_2 and the process PR executed by the electronic control device 10 belongs to the first process group, the second process group, the third process group, and the fourth process group is a seventeenth combination pattern PN_17. The measures MET included in the measure group corresponding to the seventeenth combination pattern PN_17 are the first measure MET_1, the second measure MET_2, the third measure MET_3, the fourth measure MET_4, the fifth measure MET_5, the sixth measure MET_6, and the seventh measure MET_7. The security functions SE included in the security function group corresponding to the measure group corresponding to the seventeenth combination pattern PN_17 are the first security function SE_1, the second security function SE_2, the third security function SE_3, the fourth security function SE_4, the fifth security function SE_5, the sixth security function SE_6, and the seventh security function SE_7.

### Derivation of Security Function SE

The processing circuit 102 performs a series of processes for deriving the security function SE to be implemented in the electronic control device 10. Hereinafter, a step number of each process is represented by a number with “S” attached to the head.

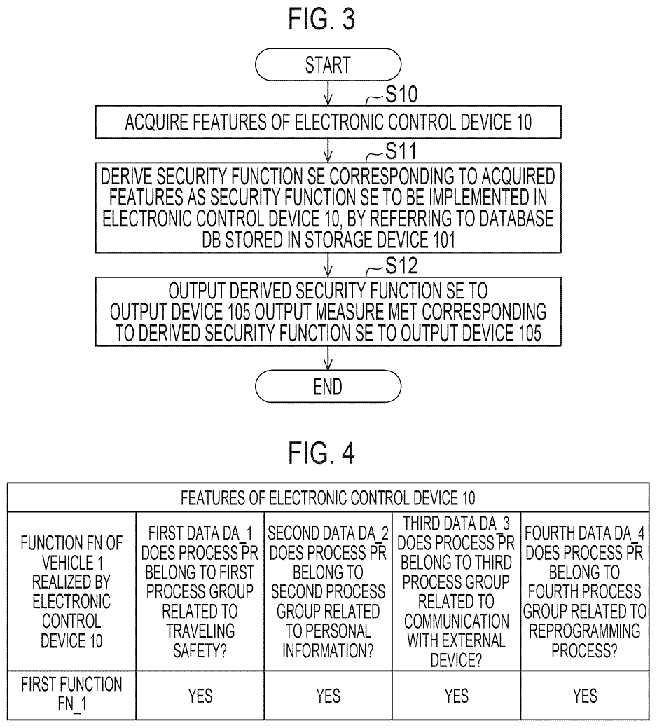

As shown in FIG. 3, in a case where the series of processes is started, in process of S10, the processing circuit 102 acquires the feature of the electronic control device 10. For example, the processing circuit 102 acquires the feature of the electronic control device 10 from information input to the input device 104 by the user of the information processing apparatus 100. Specifically, the processing circuit 102 acquires the function FN of the vehicle 1 realized by the electronic control device 10. The processing circuit 102 acquires the process PR executed by the electronic control device 10. The processing circuit 102 acquires the first data DA_1 indicating whether the acquired process PR executed by the electronic control device 10 is the process belonging to the first process group. The processing circuit 102 acquires the second data DA_2 indicating whether the acquired process PR executed by the electronic control device 10 is the process belonging to the second process group. The processing circuit 102 acquires the third data DA_3 indicating whether the acquired process PR executed by the electronic control device 10 is the process belonging to the third process group. The processing circuit 102 acquires the fourth data DA_4 indicating whether the acquired processing PR executed by the electronic control device 10 is the process belonging to the fourth processing group. Then, the processing circuit 102 acquires the combination pattern PN of the function FN of the vehicle 1 realized by the electronic control device 10, the first data DA_1, the second data DA_2, the third data DA_3, and the fourth data DA_4 as the feature of the electronic control device 10. Thereafter, the processing circuit 102 proceeds to process of S11.

FIG. 4 shows an example of the combination pattern PN acquired by the processing circuit 102 in S10. In the following description of the first embodiment, the combination pattern PN acquired by the processing circuit 102 in S10 is the combination pattern PN shown in FIG. 4.

As shown in FIG. 4, the combination pattern PN acquired by the processing circuit 102 indicates that the function FN of the vehicle 1 realized by the electronic control device 10 is the first function FN_1 among the features of the electronic control device 10. The combination pattern PN acquired by the processing circuit 102 also indicates that the process PR executed by the electronic control device 10 belongs to the first process group, the second process group, the third process group, and the fourth process group among the features of the electronic control device 10.

In S11 shown in FIG. 3, the processing circuit 102 refers to the database DB stored in the storage device 101. As a result, the processing circuit 102 derives the security function SE corresponding to the feature of the first electronic control device 11 acquired in S10 as the security function SE to be implemented in the first electronic control device 11. Specifically, the processing circuit 102 derives the security function SE included in the security function group corresponding to the acquired combination pattern PN as the security function SE to be implemented in the electronic control device 10 by referring to the database DB shown in FIG. 2.

As shown in FIG. 2, in a case where the function FN of the vehicle 1 realized by the acquired electronic control device 10 is the first function FN_1 and the process PR executed by the acquired electronic control device 10 belongs to the first process group, the second process group, the third process group, and the fourth process group, the combination pattern PN is the first combination pattern PN_1. The group of the security functions SE corresponding to the first combination pattern PN_1 is the first security function SE_1, the second security function SE_2, the third security function SE_3, the fourth security function SE_4, the fifth security function SE_5, the sixth security function SE_6, the seventh security function SE_7, and the eighth security function SE_8. Therefore, the processing circuit 102 derives the first security function SE_1, the second security function SE_2, the third security function SE_3, the fourth security function SE_4, the fifth security function SE_5, the sixth security function SE_6, the seventh security function SE_7, and the eighth security function SE_8 as the security function SE to be implemented in the electronic control device 10. Thereafter, the processing circuit 102 proceeds to process of S12.

In S12 shown in FIG. 3, the processing circuit 102 outputs the derived security function SE to the output device 105. The processing circuit 102 also outputs the measure MET corresponding to the derived security function SE to the output device 105. The processing circuit 102 displays, for example, the security function SE derived in S11 and the measure MET corresponding to the security function SE derived in S11 on the display that is the output device 105. The processing circuit 102 may be configured to print the derived security function SE and the measure MET corresponding to the derived security function SE on the output device 105. Thereafter, the processing circuit 102 ends the series of processes.

### Action of First Embodiment

The storage device 101 stores the database DB in which the result of the risk assessment performed in advance on the electronic control devices 10 provided in the vehicle 1 is organized. In the database DB, the measure MET is associated with each feature of the electronic control device 10. The security function SE is associated with each measure MET. Therefore, by inputting the feature of the electronic control device 10 to the information processing apparatus 100 with reference to the database DB, the measure MET and the security function SE for realizing the measure MET can be derived. The information processing apparatus 100 acquires the feature of the electronic control device 10 and refers to the database DB. As a result, the information processing apparatus 100 derives the security function SE for realizing the measure MET corresponding to the feature of the electronic control device 10.

### Effects of First Embodiment

(1-1) The information processing apparatus 100 can derive the security function

SE to be implemented in each electronic control device 10 without individually performing the risk assessment on each of the electronic control devices 10 provided in the vehicle 1.

(1-2) The feature of the electronic control device 10 is indicated by a combination of the function FN of the vehicle 1 realized by the electronic control device 10, the first data DA_1, the second data DA_2, the third data DA_3, and the fourth data DA_4.

The first data DA_1 indicates whether the process PR executed by the electronic control device 10 is the process belonging to a first process group including a plurality of processes related to traveling safety of the vehicle 1. The second data DA_2 indicates whether the process PR executed by the electronic control device 10 is the process belonging to a second process group including the processes related to personal information. The third data DA_3 indicates whether the process PR executed by the electronic control device 10 is the process belonging to a third process group including the processes related to communication with an external device. The fourth data DA_4 indicates whether the process PR executed by the electronic control device 10 is the process belonging to a fourth process group including the processes related to the reprogramming process of an in-vehicle device.

The storage device 101 stores the database DB based on the result of the risk assessment performed on the combination patterns PN of the function FN of the vehicle 1 realized by the electronic control device 10, the first data DA_1, the second data DA_2, the third data DA_3, and the fourth data DA_4. The database DB stores a plurality of measure groups that are data in which the measure MET against the risk present in each combination pattern PN is associated with each combination pattern PN. The database DB stores a security function group that is data in which the security function SE for realizing the measure MET included in each measure group is associated with each measure group.

The processing circuit 102 acquires the function FN of the vehicle 1 realized by the electronic control device 10. The processing circuit 102 acquires the first data DA_1, the second data DA_2, the third data DA_3, and the fourth data DA_4 for the process PR executed by the electronic control device 10. The processing circuit 102 derives the security function SE included in the security function group corresponding to the combination pattern PN of the acquired function FN, the first data DA_1, the second data DA_2, the third data DA_3, and the fourth data DA_4 as the security function SE to be implemented in the electronic control device 10.

In the database DB, a measure group is associated with each combination pattern PN. The security function group is associated with each measure group. Therefore, by inputting the acquired function FN, the first data DA_1, the second data DA_2, the third data DA_3, and the fourth data DA_4 indicating whether the acquired processing PR is the process belonging to each processing group to the combination pattern PN acquired by inputting the acquired function FN, the measure group that is a collection of measures MET against the risk present in the combination pattern PN, and the security function group that is a collection of the security functions SE for realizing the measure MET included in the measure group can be derived with reference to the database DB. That is, the processing circuit 102 can derive a variation of the group of the security functions SE to be implemented in the electronic control device 10 for each combination pattern PN according to the combination of the acquired function FN and whether the acquired process PR belongs to each process group.

(1-3) In a case where the process PR executed by the electronic control device 10 belongs to the first process group including the processes related to traveling safety of the vehicle 1, the measure MET against the risk related to the traveling safety present in the process PR is required. In a case where the process PR executed by the electronic control device 10 belongs to the second process group including the processes related to personal information, the measure MET against the risk related to the handling of the personal information present in the process PR is required. In a case where the process PR executed by the electronic control device 10 belongs to the third process group including the processes related to communication with an external device, the measure MET against the risk related to the communication with the external device present in the process PR is required. In a case where the process PR executed by the electronic control device 10 belongs to the fourth process group including the processes related to the reprogramming process of an in-vehicle device, the measure MET against the risk related to the reprogramming of the in-vehicle device present in the process PR is required.

In the database DB, the measure MET is associated with each combination pattern PN of the function FN of the vehicle 1 realized by the electronic control device 10, whether the process PR executed by the electronic control device 10 belongs to the first process group, whether the process PR belongs to the second process group, whether the process PR belongs to the third process group, and whether the function FN belongs to the fourth process group. The security function SE is associated with each measure MET. Therefore, by inputting the combination pattern PN to derive the measure MET corresponding to the combination pattern PN and the security function SE for realizing the measure MET with reference to the database DB. That is, the information processing apparatus 100 can derive the security function SE for realizing the measure MET against the risk present in the acquired process PR as the security function SE to be implemented in the electronic control device 10. For example, in a case where the risk related to the traveling safety is present in the acquired processing PR, the information processing apparatus 100 can derive the security function SE for realizing the measure MET against the risk as the security function SE to be implemented in the electronic control device 10. For example, in a case where the risk related to the handling of the personal information is present in the acquired processing PR, the information processing apparatus 100 can derive the security function SE for realizing the measure MET against the risk as the security function SE to be implemented in the electronic control device 10. For example, in a case where the risk related to the communication with the external device is present in the acquired process PR, the information processing apparatus 100 can derive the security function SE for realizing the measure MET against the risk as the security function SE to be implemented in the electronic control device 10. For example, in a case where the risk related to the reprogramming of the in-vehicle device is present in the acquired process PR, the information processing apparatus 100 can derive the security function SE for realizing the measure MET against the risk as the security function SE to be implemented in the electronic control device 10.

(1-4) The information processing apparatus 100 includes the output device 105.

The processing circuit 102 outputs the derived security function SE and the measure MET corresponding to the derived security function SE to the output device 105. The measure MET against the risk present in the feature of the electronic control device 10 is a reference document for the user of the information processing apparatus 100 to determine whether the derived security function SE is appropriate as the security function SE to be implemented in the electronic control device 10. The information processing apparatus 100 can easily allow the user of the information processing apparatus 100 to determine whether the derived security function SE is appropriate as the security function SE to be implemented in the electronic control device 10.

### Modification of First Embodiment

The first embodiment can be modified and carried out as follows. The first embodiment and the modification of the first embodiment can be implemented in combination within a technically consistent range. ·The information indicating the feature of the electronic control device 10 is not limited to the information on the belonging to the above-described four types of process groups. For example, the information indicating the feature of the electronic control device 10 may be information on the belonging to less than four of the above-described four types of process groups. For example, the information indicating the feature of the electronic control device 10 may be information on the belonging to five or more process groups including the above-described four types of process groups. For example, the information indicating the feature of the electronic control device 10 may be information on the belonging to one or a plurality of process groups having contents different from the above-described four types of process groups.

The information indicating the feature of the electronic control device 10 may not include whether the function belongs to each of the above-described four types of process groups. That is, the information indicating the feature of the electronic control device 10 may be only the function FN of the vehicle 1 realized by the electronic control device 10. In this case, in the database DB, the measure MET is associated with each function FN. The security function SE is associated with each measure MET. Therefore, by inputting the function FN to derive the measure MET and the security function SE for realizing the measure MET with reference to the database DB. The processing circuit 102 acquires the function FN of the vehicle 1 realized by the electronic control device 10. Then, the processing circuit 102 can derive the security function SE for realizing the measure MET corresponding to the acquired function FN as the security function SE to be implemented in the electronic control device 10 by referring to such a database DB. In this case, since all the security functions SE required for the function FN are derived, the number of derived security functions SE increases. On the other hand, the information processing apparatus 100 that uses only the function FN as the feature of the electronic control device 10 can derive the security function SE to be implemented in the electronic control device 10 before the detailed specification is determined.

### Second Embodiment

Hereinafter, the information processing apparatus 100 according to the second embodiment will be described with reference to FIGS. 3, 5, and 6. In the second embodiment, the difference from the first embodiment will be described. In the second embodiment, an aspect of the feature of the electronic control device 10 that is a target of the risk assessment is different from that in the first embodiment. In the second embodiment, the feature of the electronic control device 10 is indicated by the process PR executed by the electronic control device 10 and the communication message MB used by the electronic control device 10.

By performing the risk assessment on the process PR executed by the electronic control device 10, for example, a result of the risk assessment indicating what kind of risk may be present for each process PR executed by the electronic control device 10 to realize the function FN of the vehicle 1 is obtained.

By performing the risk assessment on the communication message MB used by the electronic control device 10, for example, a result of the risk assessment indicating a degree of the risk of leakage for each communication message MB and the risk of tampering for each communication message MB is obtained.

### Database DB

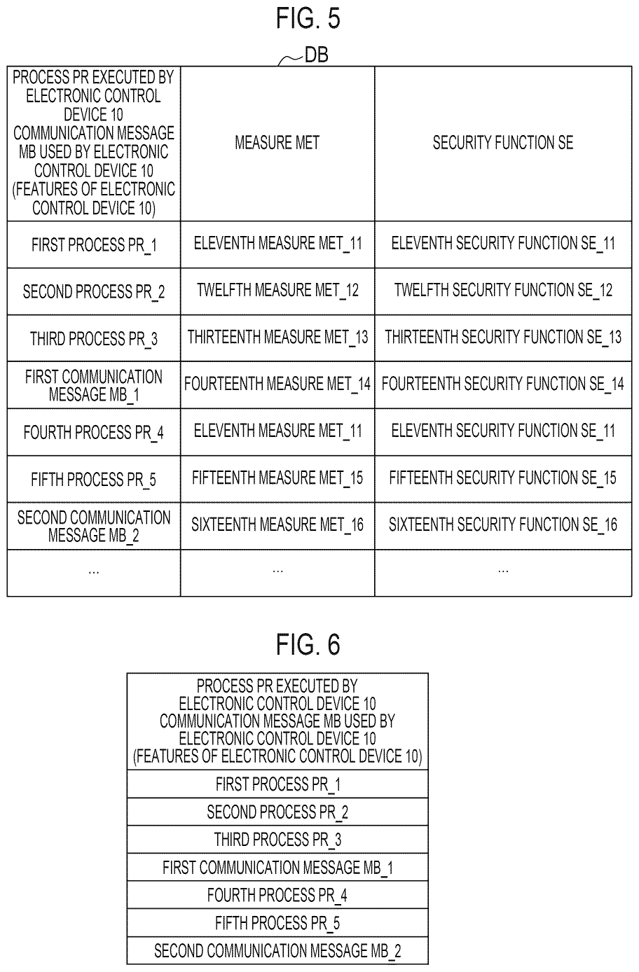

As shown in FIG. 5, the database DB includes data in which the measure MET against the risk present in each process PR is associated with each process PR. The first process PR_1, the second process PR_2, the third process PR_3, the fourth process PR_4, and the fifth process PR_5 are all the process PR executed by the electronic control device 10. The eleventh measure MET_11 is associated with the first process PR_1. The twelfth measure MET_12 is associated with the second process PR_2. The thirteenth measure MET_13 is associated with the third process PR_3. The eleventh measure MET_11 is associated with the fourth process PR_4. The fifteenth measure MET_15 is associated with the fifth process PR_5. The processes PR to which the same measure MET is associated can be aggregated into one upper process PR. For example, the first process PR_1 and the fourth process PR_4 may be aggregated into one upper process PR. In this case, the eleventh measure MET_11 is associated with the upper process PR including the first process PR_1 and the fourth process PR_4.

The database DB includes data in which the measure MET against the risk present in each communication message MB is associated with each communication message MB. The first communication message MB_1 and the second communication message MB_2 are the communication messages MB used by the electronic control device 10. The fourteenth measure MET_14 is associated with the first communication message MB_1. The sixteenth measure MET_16 is associated with the second communication message MB_2. As in the process PR, a plurality of communication messages MB to which the same measure MET is associated can be aggregated into one upper communication message MB. In this case, for example, the measure MET common to all of the communication messages MB aggregated into the upper communication message MB is associated with the upper communication message MB.

The database DB includes data in which the security function SE for realizing each measure MET is associated with each measure MET. The eleventh security function SE_11 is associated with the eleventh measure MET_11. The twelfth security function SE_12 is associated with the twelfth measure MET_12. The thirteenth security function SE_13 is associated with the thirteenth measure MET_13. The fourteenth security function SE_14 is associated with the fourteenth measure MET_14. The fifteenth security function SE_15 is associated with the fifteenth measure MET_15. The sixteenth security function SE_16 is associated with the sixteenth measure MET_16.

### Derivation of Security Function SE

The processing circuit 102 performs a series of processes for deriving the security function SE to be implemented in the electronic control device 10 by referring to the database DB.

As shown in FIG. 3, in a case where the series of processes is started, in process of S10, the processing circuit 102 acquires the feature of the electronic control device 10. Specifically, the processing circuit 102 acquires the process PR executed by the electronic control device 10 and the communication message MB used by the electronic control device 10. Thereafter, the processing circuit 102 proceeds to process of S11.

FIG. 6 shows an example of the process PR executed by the electronic control device 10 and the communication message MB used by the electronic control device 10 acquired by the processing circuit 102 in S10. In the following description of the second embodiment, the process PR and the communication message MB acquired by the processing circuit 102 in S10 are the combination pattern PN shown in FIG. 6.

As shown in FIG. 6, the process PR acquired by the processing circuit 102 in

S10 is the first process PR_1, the second process PR_2, the third process PR_3, the fourth process PR_4, and the fifth process PR_5. The communication message MB acquired by the processing circuit 102 in S10 is the first communication message MB_1 and the second communication message MB_2.

In S11 shown in FIG. 3, the processing circuit 102 refers to the database DB. As a result, the processing circuit 102 derives the security function SE corresponding to the feature of the first electronic control device 11 acquired in S10 as the security function SE to be implemented in the first electronic control device 11. Specifically, the processing circuit 102 derives the security function SE corresponding to the process PR acquired in S10 as the security function SE to be implemented in the electronic control device 10 by referring to the database DB shown in FIG. 5. Further, the processing circuit 102 also derives the security function SE corresponding to the communication message MB acquired in S10 as the security function SE to be implemented in the electronic control device 10 by referring to the database DB shown in FIG. 5.

As shown in FIG. 5, the security function SE corresponding to the first process PR_1 is the eleventh security function SE_11. The security function SE corresponding to the second process PR_2 is the twelfth security function SE_12. The security function SE corresponding to the third process PR_3 is the thirteenth security function SE_13. The security function SE corresponding to the fourth process PR_4 is the eleventh security function SE_11. The security function SE corresponding to the fifth process PR_5 is the fifteenth security function SE_15. The security function SE corresponding to the first communication message MB_1 is the fourteenth security function SE_14. The security function SE corresponding to the second communication message MB_2 is the sixteenth security function SE_16. Therefore, the processing circuit 102 derives the eleventh security function SE_11, the twelfth security function SE_12, the thirteenth security function SE_13, the fourteenth security function SE_14, the fifteenth security function SE_15, and the sixteenth security function SE_16 as the security function SE to be implemented in the electronic control device 10. Thereafter, the processing circuit 102 proceeds to process of S12.

The process of S12 in the second embodiment is the same as the process of S12 in the first embodiment, and thus the detailed description thereof will be omitted. Thereafter, the processing circuit 102 ends the series of processes.

### Action of Second Embodiment

The process PR executed by the electronic control device 10 and the communication message MB used by the electronic control device 10 are more detailed specifications than the function FN of the vehicle 1 realized by the electronic control device 10. The storage device 101 stores the database DB in which the result of the risk assessment performed in advance on the process PR and the communication message MB that are more detailed specifications than the function FN of the vehicle 1 realized by the electronic control device 10 is organized. In the database DB, the measure MET is associated with each process PR. In the database DB, the measure MET is associated with each communication message MB.

The measure MET in the second embodiment is the measure MET against the risk obtained by performing the risk assessment on the process PR and the communication message MB that are more detailed specifications than the function FN of the vehicle 1 realized by the electronic control device 10. Therefore, the measure MET in the second embodiment is the measure MET in which the measure MET against the risk unnecessary for the process PR is removed and the measure MET in which the measure MET against the risk unnecessary for the communication message MB is removed. The security function SE associated with each measure MET in which the measure MET against the risk unnecessary for the process PR is removed is the security function SE for realizing the measure MET against the risk in which the risk unnecessary for the process PR is removed. The processing circuit 102 acquires the process PR executed by the electronic control device 10 as the feature of the electronic control device 10. Therefore, the processing circuit 102 can derive the security function SE for realizing the measure MET against the risk in which the measure MET against the risk unnecessary for the acquired process PR is removed by referring to the database DB. The security function SE associated with each measure MET in which the measure MET against the risk unnecessary for the communication message MB is removed is the security function SE for realizing the measure MET against the risk in which the risk unnecessary for the communication message MB is removed. The processing circuit 102 acquires the communication message MB used by the electronic control device 10 as the feature of the electronic control device 10. Therefore, the processing circuit 102 can derive the security function SE for realizing the measure MET against the risk in which the measure MET against the risk unnecessary for the acquired communication message MB is removed by referring to the database DB. That is, the processing circuit 102 derives the security function SE for realizing the measure MET against the risk in which the measure MET against the risk unnecessary for the electronic control device 10 is removed as the security function SE to be implemented in the electronic control device 10.

### Effects of Second Embodiment

In the second embodiment, the following effects are exhibited in addition to the effects shown in (1-1) and (1-4) of the first embodiment.

(2-1) The information processing apparatus 100 can suppress the unnecessary security function SE for the electronic control device 10 from being implemented in the electronic control device 10.

### Modification of Second Embodiment

The second embodiment can be modified and carried out as follows.

The processing circuit 102 may acquire only the process PR executed by the electronic control device 10 as the information indicating the feature of the electronic control device 10 among the process PR executed by the electronic control device 10 and the communication message MB used by the electronic control device 10. In this case, the storage device 101 need only store the measure MET associated with each process PR among the measure MET associated with each process PR and the measure MET associated with each communication message MB. The processing circuit 102 derives the security function SE corresponding to the process PR executed by the electronic control device 10 as the security function SE to be implemented in the electronic control device 10. The processing circuit 102 may acquire only the communication message MB used by the electronic control device 10 among the process PR executed by the electronic control device 10 and the communication message MB used by the electronic control device 10. In this case, the storage device 101 need only store the measure MET associated with each communication message MB among the measure MET associated with each process PR and the measure MET associated with each communication message MB. The processing circuit 102 derives the security function SE corresponding to the communication message MB used by the electronic control device 10 as the security function SE to be implemented in the electronic control device 10.

### Other Modifications

In addition, examples of elements that can be changed in common to each of the above-described embodiments include the following. The following modifications can be implemented in combination within a technically consistent range.
The electronic control device from which the processing circuit 102 acquires the feature is not limited to the electronic control devices 10 that are the target of the risk assessment for creating the database DB. That is, the processing circuit 102 can acquire the feature of the electronic control device that is not the target of the risk assessment for creating the database DB. The processing circuit 102 can derive the security function SE for realizing the measure MET corresponding to the feature of the electronic control device by referring to the database DB. That is, the electronic control device from which the information processing apparatus 100 can derive the security function SE without individually performing the risk assessment is not limited to the electronic control devices 10 provided in the vehicle 1. For example, the information processing apparatus 100 can derive the security function SE without individually performing the risk assessment on the electronic control device that is scheduled to be implemented in the vehicle 1. For example, the information processing apparatus 100 can derive the security function SE without individually performing the risk assessment on the electronic control device provided in the vehicle other than the vehicle 1.

In the processing of S12 shown in FIG. 3, the processing circuit 102 may output only the derived security function SE to the output device 105.
The processing circuit 102 may not output the derived security function SE to the output device 105 in a case of deriving the security function SE to be implemented in the electronic control device 10. For example, the processing circuit 102 may be configured to store the derived security function SE in the storage device 101 without outputting the derived security function SE to the output device 105. In this case, the information processing apparatus 100 may not include the output device 105.

The processing circuit 102 may be configured as a circuit (circuitry) including one or more processors that execute various types of process in accordance with a computer program (software). The processing circuit 102 may be configured as a circuit including one or more dedicated hardware circuits, such as an application-specific integrated circuit (ASIC), which executes at least a part of various types of process, or a combination thereof. The processor includes a CPU and a memory, such as a RAM and a ROM. The memory stores a program code or an instruction configured to cause the CPU to execute the process. The memory, that is, a computer-readable medium includes any usable medium accessible by a general-purpose or dedicated computer.

What is claimed is:

1. An information processing apparatus that derives a security function to be implemented in an electronic control device mounted on a vehicle, the information processing apparatus comprising:
a storage device; and
a processing circuit, wherein:
the storage device stores a database based on a result of risk assessment performed on features of a plurality of electronic control devices that realize a plurality of functions of the vehicle, the database including
for each feature, data in which a measure against a risk present in each feature is associated with the feature, and
for each measure, data in which the security function for realizing each measure is associated with the measure; and
the processing circuit executes
acquiring the features of the electronic control device, and
deriving, by referring to the database stored in the storage device, the security function corresponding to the features that are acquired, as the security function to be implemented in the electronic control device.

2. The information processing apparatus according to claim 1, wherein:
the features are indicated by the functions of the vehicle realized by the electronic control device;
the storage device stores a database based on a result of risk assessment performed on the functions of the vehicle, the database including
for each function, data in which a measure against a risk present in each function is associated with the function, and
for each measure, data in which the security function for realizing each measure is associated with the measure; and
the processing circuit executes
acquiring the functions of the vehicle realized by the electronic control device, and
deriving, by referring to the database stored in the storage device, the security function corresponding to the functions that are acquired, as the security function to be implemented in the electronic control device.

3. The information processing apparatus according to claim 1, wherein:
the features are indicated by a combination of
the functions of the vehicle realized by the electronic control device,
first data indicating whether a process executed by the electronic control device is a process belonging to a first processing group including a plurality of processes related to traveling safety of the vehicle,
second data indicating whether the process executed by the electronic control device is a process belonging to a second processing group including a plurality of processes related to personal information,
third data indicating whether the process executed by the electronic control device is a process belonging to a third processing group including a plurality of processes related to communication with an external device, and
fourth data indicating whether the process executed by the electronic control device is a process belonging to a fourth processing group including a plurality of processes related to a reprogramming process of an in-vehicle device;
the storage device stores a database based on a result of risk assessment performed on a plurality of combination patterns of the functions, the first data, the second data, the third data, and the fourth data, the database including
for each combination pattern, data in which a measure against a risk present in each combination pattern is associated with the combination patterns, and
for each measure, data in which the security function for realizing each measure is associated with the measure; and
the processing circuit executes
acquiring the functions of the vehicle realized by the electronic control device, the first data, the second data, the third data, and the fourth data, and
deriving, by referring to the database stored in the storage device, a group of the security functions corresponding to the functions that are acquired, the first data, the second data, the third data, and the fourth data, in the combination patterns, as the security function to be implemented in the electronic control device.

4. The information processing apparatus according to claim 1, wherein:
the features are indicated by a process executed by the electronic control device to realize a function of the vehicle and a communication message used by the electronic control device to realize the function of the vehicle;
the storage device stores a database based on a result of risk assessment performed on a plurality of the processes and a plurality of the communication messages, the database including
for each process, data in which a measure against a risk present in each process is associated with the process,
for each measure against the risk present in each process, data in which the security function for realizing each measure against the risk present in each process is associated with the measure,
for each communication message, data in which a measure against a risk present in each communication message is associated with the communication message, and
for each measure against the risk present in each communication message, data in which a security function for realizing each measure against the risk present in each communication message is associated with the measure; and
the processing circuit executes
acquiring the process executed by the electronic control device to realize the function of the vehicle and the communication message used by the electronic control device to realize the function of the vehicle, and
deriving, by referring to the database stored in the storage device, the security function corresponding to the process that is acquired and the communication message that is acquired, as the security function to be implemented in the electronic control device.

5. The information processing apparatus according to claim 1, further comprising an output device,
wherein the processing circuit executes a process of outputting the security function that is derived and the measure corresponding to the security function that is derived to the output device.
